(19) United States
(12) Patent Application Publication
(10) Pub. No.: US 2006/0056831 A1
(43) Pub. Date: Mar. 16, 2006

(54) Digital camera

(75) Inventors: Takeshi Horio, Osaka (JP); Hiroshi Ueda, Osaka (JP); Kimihiko Nakamura, Osaka (JP); Junji Takahata, Osaka (JP); Akio Kimba, Osaka (JP); Masayuki Miyazawa, Osaka (JP)

Correspondence Address: BRINKS HOFER GILSON & LIONE, P.O. BOX 10395, CHICAGO, IL, 60610, US

(73) Assignee: KONICA MINOLTA PHOTO IMAGING, INC.

(21) Appl. No.: 11/223,428

(22) Filed: Sep. 9, 2005

(30) Foreign Application Priority Data
Sep. 13, 2004 (JP) 2004-265890

(51) Int. Cl. G03B 17/00

(52) U.S. Cl. 396/55

(57) ABSTRACT

A digital camera body to which a lens unit having an image taking optical system is attachable. The camera body has a shake detector detecting a camera shake on the digital camera and outputting a shake detection signal, a blur compensator compensates for a blur, due to the camera shake, of a subject light image projected onto an image capturing surface of an image sensor provided in the camera body, based on an inputted blur compensation amount, a focal length deriver obtaining an overall focal length of the image taking optical system, by use of the information on the focal length obtained from the lens unit, and a blur compensation controller deriving the blur compensation amount for compensating for the blur based on the overall focal length of the image taking optical system and the shake detection signal, and outputting the blur compensation amount to the blur compensator.

### CROSS-REFERENCE TO RELATED APPLICATION

This application is based on Japanese Patent Application No. 2004-265890 filed in Japan on Sep. 13, 2004, the entire content of which is hereby incorporated by reference.

### BACKGROUND OF THE INVENTION

1. Field of the Invention

The present invention belongs to the technical field of single-lens reflex digital cameras, and more particularly, relates to a blur compensation technology to compensate for a blur of a captured image caused due to a camera shake.

2. Description of the Related Art

An example of conventional interchangeable lenses attached to single-lens reflex cameras is one in which a zoom lens for varying the magnification is provided and the zoom lens is driven in the direction of the optical axis by an operation of an operation ring provided on the interchangeable lens. Moreover, an interchangeable lens is known in which a focusing lens for performing focus adjustment is provided and when the interchangeable lens is attached to the camera body, the focusing lens is driven in the direction of the optical axis by a driver in the camera body to which the interchangeable lens is attached. Further, an interchangeable lens is known in which the focusing lens and a driver that drives the focusing lens in the direction of the optical axis are provided and a lens controller that controls the driving of the driver when the interchangeable lens is attached to the camera body is also provided.

On the other hand, among single-lens reflex cameras comprising a camera body and an interchangeable lens structured so as to be detachably attachable to the camera body, one has conventionally been proposed in which the interchangeable lens is provided with a function to perform blur compensation.

In interchangeable lenses having a magnification varying function, even when the photographing magnification is the same, the distance from the image capturing surface of the image sensor to the rear principal point (hereinafter, referred to as focal length) differs according to the kind of the zoom lens. Moreover, in interchangeable lenses having a focus adjustment function in addition to the magnification varying function, when the focusing lens is driven to perform focus adjustment after the magnification of the zoom lens is set, the determined focal length further changes according to the set photographing magnification. Further, even in interchangeable lenses having a fixed focal length lens, the focal length might be changed when the focusing lens is driven to perform focus adjustment.

When it is considered to provide a single-lens reflex camera with a blur compensation function, since the amount of compensation for the blur differs according to the set focal length even when the shake occurring on the camera is the same, in order to appropriately perform blur compensation in the single-lens reflex camera, it is necessary to derive the focal length according to the interchangeable lens attached to the camera body and perform compensation according to the focal length.

In that case, when the blur compensation function is provided in each interchangeable lens as conventionally proposed, it is necessary that each interchangeable lens be provided with a sensor that detects the shake, a circuit that calculates the blur compensation amount and the like, so that cost increases and the size of the interchangeable lens increases.

### SUMMARY OF THE INVENTION

A principal object of the present invention is to provide a single-lens reflex digital camera capable of performing appropriate blur compensation according to the interchangeable lens attached to the camera body.

Another object of the present invention is to provide a single-lens reflex digital camera capable of performing appropriate blur compensation according to the interchangeable lens attached to the camera body while preventing or suppressing cost increase and size increase of the interchangeable lens.

The above-mentioned objects are attained by providing a digital camera comprising a camera body, and a lens unit detachable from said camera body and having an image taking optical system. The camera body further comprising a communication portion configured to receive an information on a focal length of the image taking optical system from the lens unit; a shake detector that detects a camera shake on the digital camera, and outputs a shake detection signal; a blur compensator configured to receive a blur compensation amount and compensates for a blur, due to the camera shake, of a subject light image projected onto an image capturing surface of an image sensor provided in the camera body, based on the received blur compensation amount; a focal length deriver configured to obtain an overall focal length of the image taking optical system, by use of the information on the focal length obtained by the communication portion; and a blur compensation controller configured to derive the blur compensation amount for compensating for the blur based on the overall focal length of the image taking optical system obtained by the focal length deriver and the shake detection signal outputted from the shake detector, and outputs the blur compensation amount to the blur compensator.

These and other objects, advantages and features of the invention will become apparent from the following description thereof taken in conjunction with the accompanying drawings, which illustrate specific embodiments of the invention.

### BRIEF DESCRIPTION OF DRAWINGS

These and other objects, advantages and features of the invention will become apparent from the following description thereof taken in conjunction with the accompanying drawings in which:

FIG. 1 is a front view showing the structure of a digital camera according to the present invention;

FIG. 2 is a rear view showing the structure of the digital camera;

FIG. 3 is a view showing the internal structure of the digital camera;

FIGS. 4(a) and 4(b) are schematic views showing the supporting and driving structure of an image sensor;

FIGS. 5(a) and 5(b) are views showing the structure of an X-axis actuator and a Y-axis actuator;

FIG. 6 is a view showing the structure when an in-unit AF driving type lens unit is attached;

FIG. 7 is a block diagram showing the electric structure of the digital camera 1 when the in-unit AF driving type lens unit is attached to the camera body;

FIG. 8 is a view for explaining the calculation method of a blur amount ΔZ;

FIG. 9 is a view showing data transmitted from the lens unit to a main controller of the camera body when each lens unit is attached to the camera body;

FIG. 10 is a view showing the relationship between the coupler rotation number and the focal length in a certain lens unit;

FIG. 11 is a view showing a table stored in a storage;

FIG. 12 is a view showing the detailed structure of mechanisms (the image sensor, a blur compensation controller, an image sensor driving mechanism) performing blur compensation;

FIG. 13 is a view showing the waveform of a driving pulse applied to piezoelectric elements of the X-axis actuator and the Y-axis actuator;

FIG. 14 is a flowchart showing the processing performed according to the kind of the lens unit attached to the camera body; and

FIG. 15 is a flowchart showing a series of image capturing processings by the digital camera.

### DESCRIPTION OF THE PREFERRED EMBODIMENTS

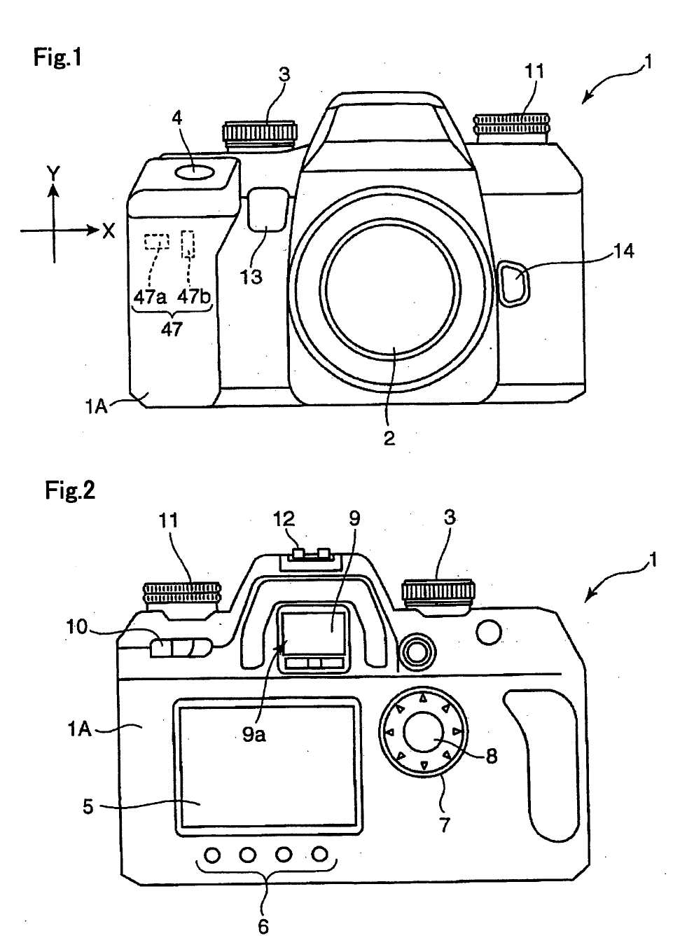

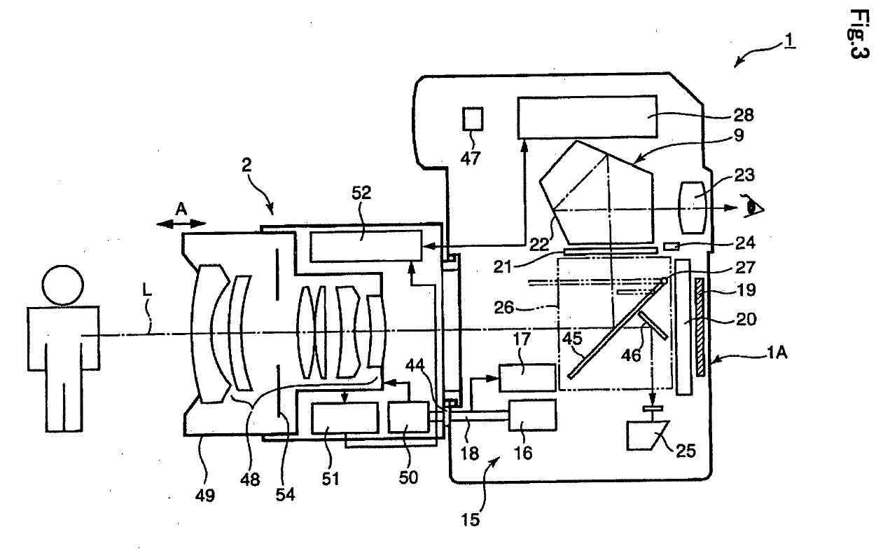

Hereinafter, an embodiment of the digital camera according to the present invention will be described. FIG. 1 is a front view showing the structure of the digital camera. FIG. 2 is a rear view showing the structure of the digital camera. FIG. 3 is a view showing the internal structure of the digital camera. In FIGS. 1 to 3, like members are denoted by like reference numerals.

As shown in FIGS. 1 and 2, the digital camera 1 according to the present embodiment is a single-lens reflex camera in which a lens unit 2 is interchangeably attached to a box-shaped camera body 1A. The digital camera 1 is provided with: the lens unit 2 attached substantially to the center of the front surface of the camera body 1A; a first mode setting dial 3 disposed in an appropriate position on the top surface; a shutter button 4 disposed on an upper corner; an LCD (liquid crystal display) 5 disposed on the left side of the rear surface; setting buttons 6 disposed below the LCD 5; a jog dial 7 disposed on a side of the LCD 5; a push button 8 disposed inside the jog dial 7; an optical viewfinder 9 disposed above the LCD 5; a main switch 10 disposed on a side of the optical viewfinder 9; a second mode setting dial 11 disposed in the vicinity of the main switch 10; a connection terminal 12 disposed above the optical viewfinder 9; and an AF fill-in light emitter 13 disposed in an appropriate position of the front surface.

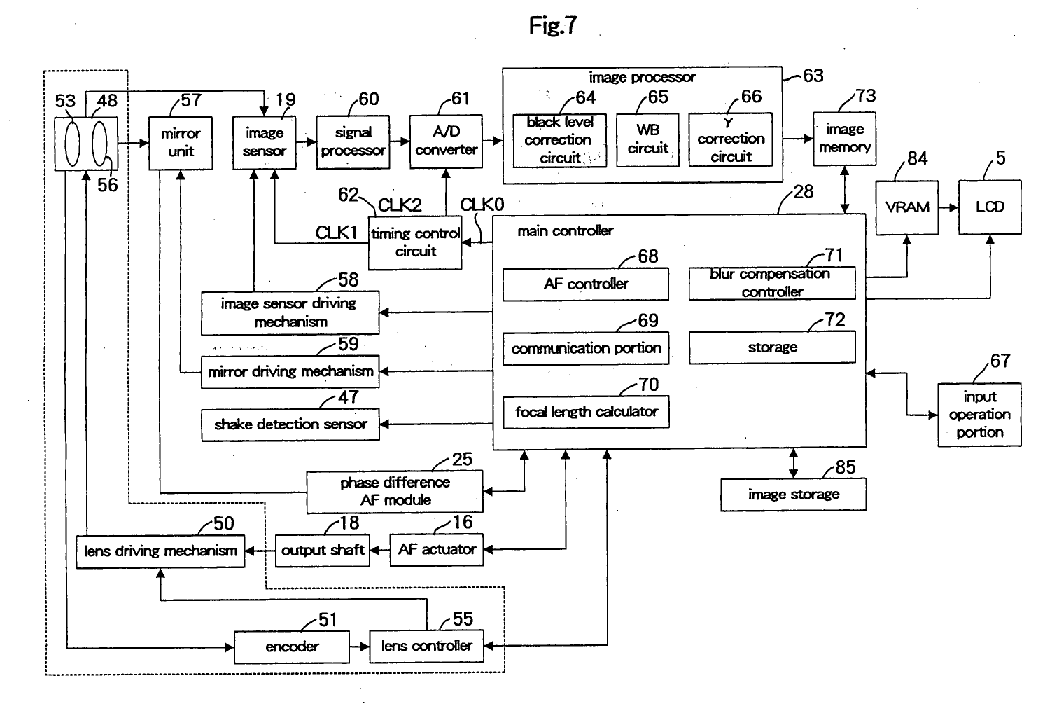

The lens unit 2 comprises a plurality of lenses as optical elements arranged in a direction vertical to the plane of the figure within the lens barrel. As optical elements incorporated in the lens unit 2, a zoom lens 53 performing magnification varying (see FIG. 7) and a focusing lens 56 for performing focus adjustment (see FIG. 7) are provided. By these lenses being driven in the direction of the optical axis, magnification varying and focus adjustment are performed.

The lens unit 2 of the present embodiment has, in an appropriate position of the periphery of its lens barrel, an operation ring that is rotatable along the periphery of the lens barrel. The zoom lens 53 is a manual zoom lens that is moved in the direction of the optical axis in accordance with the rotation direction and rotation amount of the operation ring and is set at a zoom magnification (photographing magnification) corresponding to the position to which the zoon lens 53 is moved. The lens unit 2 can be detached from the camera body 1A by depressing a detachment button 14 shown in FIG. 1.

The first mode setting dial 3 is a substantially disk-shaped member rotatable within a plane substantially parallel to the top surface of the digital camera 1, and is provided for alternatively selecting a mode or a function provided in the digital camera 1 such as a photographing mode to take a still image or a moving image and a playback mode to play back a recorded image. Although not shown, on the top surface of the first mode setting dial 3, characters representative of the functions are printed at predetermined intervals along the perimeter, and the function corresponding to the character that is set at the position opposed to the index provided in an appropriate position on the side of the camera body 1A is executed.

The shutter button 4 is a button depressed in two steps of being half depressed and being fully depressed, and is provided mainly for specifying the timing of the exposure control. By the shutter button 4 being half depressed, the digital camera 1 is set in an exposure standby state in which the setting of exposure control values (the shutter speed and the aperture value) and the like is performed, and by the shutter button 4 being fully depressed, the optical image of the subject recorded into an image storage 85 described later (see FIG. 7) is determined. The half depression of the shutter button 4 is detected by a non-illustrated switch S1 being turned on, and the full depression of the shutter button 4 is detected by a non-illustrated switch S2 being turned on.

The LCD 5 which comprises a color liquid crystal panel performs the display of an image captured by an image sensor 19 (see FIG. 3), the playback display of a recorded image and the like, and displays the setting screens of the functions and modes provided in the digital camera 1. An organic EL display or a plasma display may be used instead of the LCD 5.

The setting buttons 6 (FIG. 2) are buttons for performing operations associated with various functions provided in the digital camera 1.

The jog dial 7 has an annular member having a plurality of depression parts (the triangular parts in the figure) arranged at predetermined intervals in the circumferential direction, and is structured so that the depression of each depression part is detected by a non-illustrated contact (switch) provided so as to correspond to each depression part. The push button 8 is disposed in the center of the jog dial 7. The jog dial 7 and the push button 8 are provided for inputting instructions as to the change of the photographing magnification (the movement of the zoom lens in the wide-angle direction or the telephoto direction), the frame advance of the recorded image played back on the LCD 5, the setting of the photographing conditions (the aperture value, the shutter speed, the presence or absence of flash light emission, etc.), and the like.

The optical viewfinder 9 optically displays the range in which the subject is photographed.

The main switch 10 is a two-position slide switch that slides horizontally. When the main switch 10 is set at the left position, the power of the digital camera 1 is turned on, and when it is set at the right position, the power is turned off.

The second mode setting dial 11 has a similar mechanical structure to the first mode setting dial 3, and is provided for performing operations associated with various functions provided in the digital camera 1. The connection terminal 12 is a terminal for connecting an external device such as a non-illustrated flash device to the digital camera 1.

The AF fill-in light emitter 13 comprises a light emitting device such as an LED, and outputs fill-in light when focus adjustment is performed in a case where the brightness and contrast of the subject are low.

The digital camera 1 has a shake detection sensor 47 in an appropriate position of the camera body 1A. The shake detection sensor 47 comprises, when a two-dimensional coordinate system with the horizontal direction of FIG. 1 as the X-axis and the direction vertical-to the X-axis as the Y-axis is assumed, an X sensor 47a that detects a camera shake in the direction of the X-axis and a Y sensor 47b that detects a camera shake in the direction of the Y-axis. The X sensor 47a and the Y sensor 47b each comprise, for example, a gyro using a piezoelectric element, and detect the angular velocity of the shake in each direction.

As shown in FIG. 3, the following are provided in the camera body 1A: an AF driving unit 15; the image sensor 19; a shutter unit 20; the optical viewfinder 9; a phase difference AF module 25; a mirror box 26; and a main controller 28.

The AF driving unit 15 is provided with an AF actuator 16, an encoder 17 and an output shaft 18. The AF actuator 16 includes a motor generating a driving source such as a DC motor, a stepping motor or an ultrasonic motor and a non-illustrated reduction system for reducing the RPM of the motor.

Although not described in detail, the encoder 17 is provided for detecting the rotation amount transmitted from the AF actuator 16 to the output shaft 18. The detected rotation amount is used for calculating the position of an image capturing optical system 48 in the lens unit 2. The output shaft 18 is provided for transmitting the driving force outputted from the AF actuator 16, to a lens driving mechanism 50 in the lens unit 2.

The image sensor 19 is disposed substantially parallel to the rear surface of the camera body 1A in a rear surface side area of the camera body 1A. The image sensor 19 is, for example, a CCD (charge coupled device) color area sensor of a Bayer arrangement in which a plurality of photoelectric conversion elements each comprising a photodiode or the like are two-dimensionally arranged in a matrix and color filters of, for example, R (red), G (green) and B (blue) having different spectral characteristics are disposed at a ratio of 1:2:1 on the light receiving surfaces of the photoelectric conversion elements. The image sensor 19 converts the light image of the subject formed by the image capturing optical system 48 into analog electric signals (image signals) of color components of R (red), G (green) and B (blue), and outputs them as image signals of R, G and B. The image sensor 19 may comprise a solid-state image sensor such as a CMOS (complementary metal-oxide semiconductor).

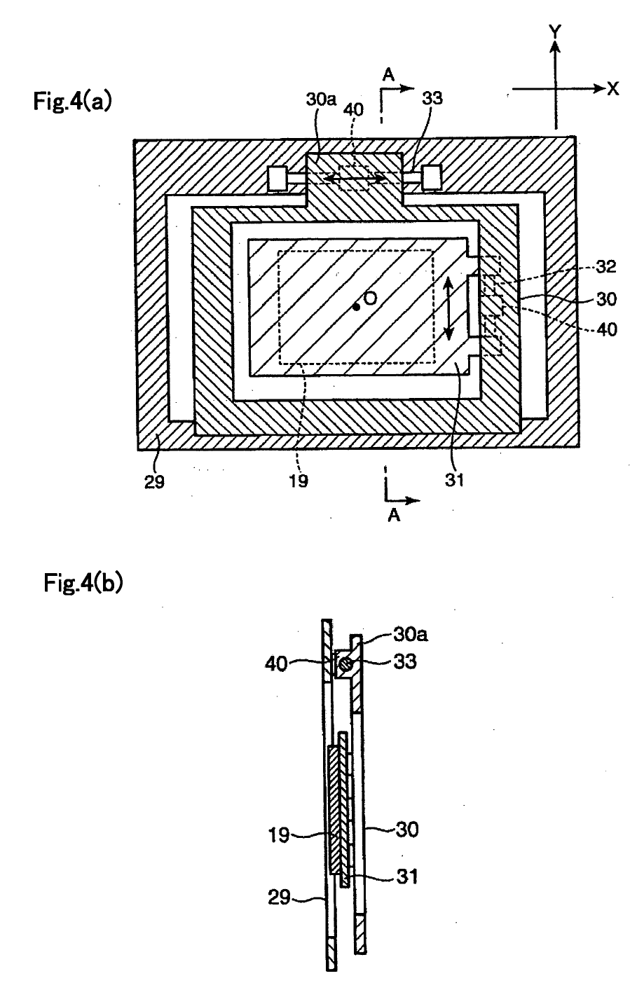

FIGS. 4(a) and 4(b) are views showing the supporting and driving structure of the image sensor 19. FIG. 4(a) is a view viewed from the surface opposite to the image capturing surface of the image sensor 19. FIG. 4(b) is a view taken on the arrow A-A of FIG. 4(a). As shown in FIG. 4(a), with respect to the image capturing surface of the image sensor 19, a two-dimensional coordinate system (corresponding to the two-dimensional coordinate system that is set in FIG. 1) with the directions of the sides as the X-axis and the Y-axis is set.

The supporting and driving structure of the image sensor 19 comprises a first to third substrates 29 to 31 having a substantially rectangular shape, an X-axis actuator 33 and a Y-axis actuator 32. The first substrate 29 is a hollow member fixed to the camera body 1A, and the X-axis actuator 33 is attached to an upper central position of the first substrate 29. The second substrate 30 is a hollow member coupled to the X-axis actuator 33. To the right side of the third substrate 31, the Y-axis actuator 32 is attached, and to the plate surface of the third substrate 31, the image sensor 19 is fixed. The movements of the second substrate 30 and the third substrate 31 in the X-axis direction and in the Y-axis direction are guided by non-illustrated rail members in predetermined positions.

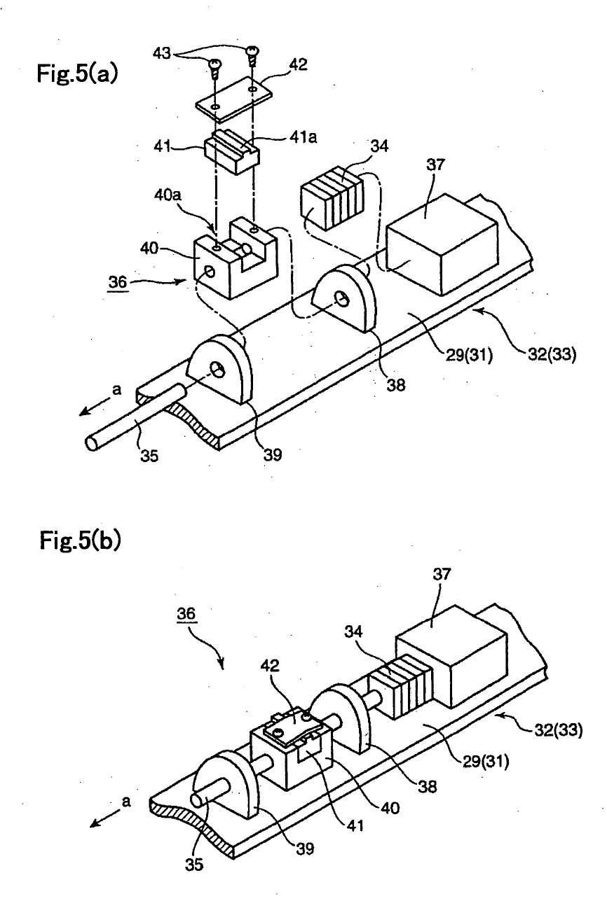

FIGS. 5(a) and 5(b) are views showing the structure of the X-axis actuator 33 and the Y-axis actuator 32. As shown in FIGS. 5(a) and 5(b), the X-axis actuator 33 and the Y-axis actuator 32 have a substantially similar structure, and comprise a piezoelectric element 34, a driving shaft 35 bonded to one end of the piezoelectric element 34, and a frictional coupling portion 36 frictionally coupled to the driving shaft 35.

The piezoelectric element 34 comprises a plurality of piezoelectric plates bonded together, and when a voltage is applied, expands or contracts by an amount corresponding to the applied voltage. The other end of the piezoelectric element 34 is bonded to a support block 37 on the substrate 29 or 31. The driving shaft 35 is supported by supports 38 and 39 on the substrate 29 or 31 so as to be movable in the lamination direction of the piezoelectric plates constituting the piezoelectric element 34, and when an expansion or contraction displacement in the direction of the thickness occurs on the piezoelectric element 34 bonded to the end of the driving shaft 35, the driving shaft 35 moves in the axial direction.

The frictional coupling portion 36 has: a slider 40 through which the driving shaft 35 passes and that is frictionally coupled to the driving shaft 35 from below; a pad 41 that is inserted in a notch 40a formed on the upper side of the slider 40 and is frictionally coupled to the driving shaft 35 from above; and a plate spring 42 that adjusts the frictional coupling force between the driving shaft 35, and the slider 40 and the pad 41. A protrusion 41a formed on the pad 41 abuts on the plate spring 42, and the frictional coupling force can be adjusted by adjusting the clamping force of a screw 43 that fixes the plate spring 42 to the slider 40.

As shown in FIGS. 4(a) and 4(b), the second substrate 30 has a protrusion 30a protruding upward in the center of the upper end, and the slider 40 is integrally formed on the first substrate 29 side surface of the protrusion 30a. By the frictional coupling of the slider 40 and the driving shaft 35 of the X-axis actuator 33, the first substrate 29 and the second substrate 30 are coupled together through the X-axis actuator 33, and the second substrate 30 is relatively movable in the direction of the X-axis with respect to the first substrate 29.

Moreover, in the center of the first substrate 29 side surface of the second substrate 30 on the right end, the slider 40 is integrally formed, and by the frictional coupling of the slider 40 and the driving shaft 35 of the Y-axis actuator 32, the third substrate 31 and the second substrate 30 are coupled together through the Y-axis actuator 32, and the third substrate 31 is relatively movable in the direction of the Y-axis with respect to the second substrate 30.

According to the above-described structure, a voltage corresponding to the result of the detection by the shake detection sensor 47 is applied to the piezoelectric elements 34 of the X-axis actuator 33 and the Y-axis actuator 34, whereby the image sensor 19 of the present embodiment is driven in the directions of the X- and Y-axes by the Y-axis actuator 32 and the X-axis actuator 33 so that the relative position of the subject light image with respect to the image capturing surface of the image sensor 19 is maintained fixed and the blur of the subject light image directed to the image capturing surface of the image sensor 19 is optically corrected. The voltage applied to the piezoelectric elements 34 will be described later.

Returning to FIG. 3, the shutter unit 20 comprises a focal plane shutter (hereinafter, referred merely to shutter), and is disposed between the rear surface of the mirror box 26 and the image sensor 19.

The optical viewfinder 9 is disposed above the mirror box 26 disposed substantially in the center of the camera body 1A, and comprises a focusing screen 21, a prism 22, an eyepiece lens 23 and a finder display element 24. The prism 22 is provided for horizontally flipping the image on the focusing screen 21 and directing it to the user's eye through the eyepiece lens 23 so that the subject image can be viewed. The finder display element 24 displays the shutter speed, the aperture value, the exposure compensation value and the like in a lower part of a display screen formed within a finder field frame 9a (see FIG. 2).

The phase difference AF module 25 is disposed below the mirror box 26, and is provided for detecting the in-focus position by a known phase difference detection method. The phase difference AF module 25 has a structure disclosed, for example, in U.S. Pat. No. 5,974,241 proposed by the applicant, and a detailed description of the structure is omitted.

The mirror box 26 comprises a quick return mirror 45 and a sub mirror 46. The quick return mirror 45 is structured so as to be pivotable about a pivot axis 27 between a position inclined substantially 45° with respect to the optical axis L of the image capturing optical system 48 as shown by the solid line of FIG. 3 (hereinafter, referred to as inclined position) and a position substantially parallel to the bottom surface of the camera body 1A as shown by the virtual line of FIG. 3 (hereinafter, referred to as horizontal position).

The sub mirror 46 is disposed on the rear surface side of the quick return mirror 45 (the side of the image sensor 19), and is structured so as to be displaceable in conjunction with the quick return mirror 45 between a position inclined substantially 90° with respect to the quick return mirror 45 in the inclined position as shown by the solid line of FIG. 3 (hereinafter, referred to as inclined position) and a position substantially parallel to the quick return mirror 45 in the horizontal position as shown by the virtual line of FIG. 3 (hereinafter, referred to as horizontal position). The quick return mirror 45 and the sub mirror 46 are driven by a mirror driving mechanism 59 described later (see FIG. 7).

When the quick return mirror 45 and the sub mirror 46 are in the inclined position, the quick return mirror 45 reflects most of the luminous flux by the image capturing optical system 48 toward the focusing screen 21 and transmits the remaining luminous flux, and the sub mirror 46 directs the luminous flux transmitted by the quick return mirror 45 to the phase difference AF module 25.

At this time, the display of the subject image by the optical viewfinder 9 and the focus adjustment according to the phase difference detection method by the phase difference AF module 25 are performed, whereas the display of the subject image by the LCD 5 is not performed because no luminous flux is directed to the image sensor 19.

On the other hand, when the quick return mirror 45 and the sub mirror 46 are in the horizontal position, since the quick return mirror 45 and the sub mirror 46 are retracted from the optical axis L, substantially all the luminous flux transmitted by the image capturing optical system 48 is directed to the image sensor 19.

At this time, the display of the subject image by the LCD 5 is performed, whereas the display of the subject image by the optical viewfinder 9 and the focus adjustment according to the phase difference detection method by the phase difference AF module 25 are not performed.

The main controller 28 comprises, for example, a microcomputer incorporating a storage such as a ROM storing a control program and a flash memory temporarily storing data. A detailed function thereof will be described later.

The shake detection sensor 47 corresponds to the shake detection sensor 47 (the X sensor 47a and the Y sensor 47b) shown in FIG. 1. In FIG. 3, the X sensor 47a and the Y sensor 47b are collectively shown as one sensor.

Next, the lens unit 2 attached to the camera body 1A will be described.

In the present embodiment, to the camera body 1A, the following two kinds of lens units can be attached: a lens unit that is subject to the driving control of the focusing lens 56 (hereinafter, referred to as AF control) from the camera body 1A; and a lens unit that performs the driving control of the focusing lens 56 by a controller (a lens driver 55 described later) within the lens unit without subjected to the AF control from the camera body 1A.

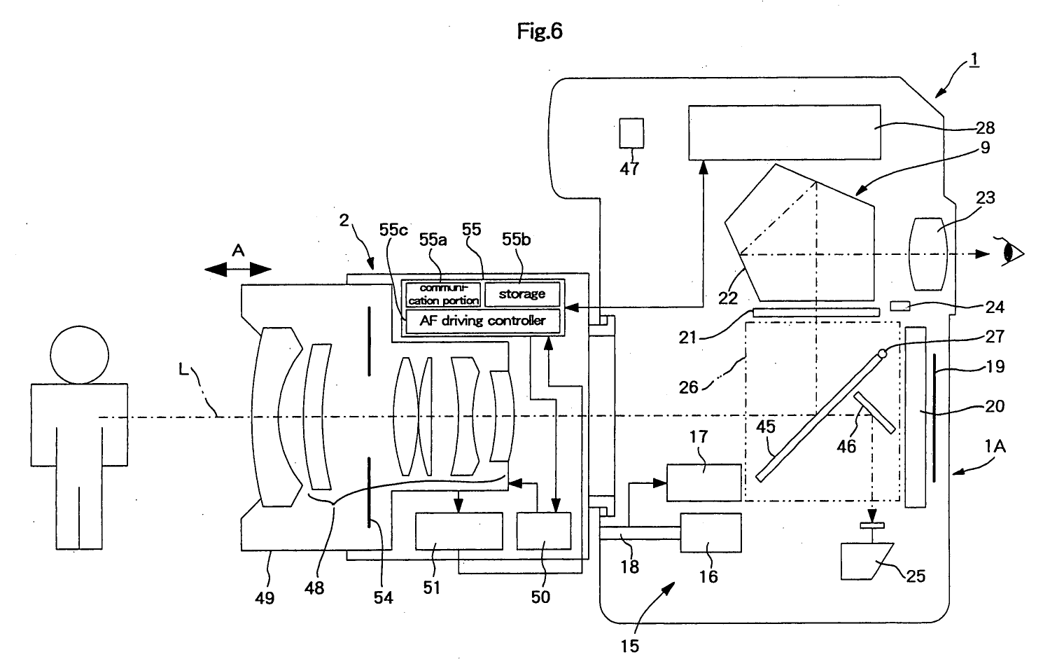

Designating the former lens unit as body AF driving type lens unit and the latter lens unit as in-unit AF driving type lens unit, FIG. 3 is a view showing the structure when the body AF driving type lens unit is attached to the camera body 1A. Moreover, the structure when the in-unit AF driving type lens unit is attached is shown in FIG. 6. These lens units are denoted by the same reference numeral, and like members are denoted by like reference numerals.

As shown in FIG. 3, the body AF driving type lens unit 2 comprises the image capturing optical system 48, a lens barrel 49, the lens driving mechanism 50, an encoder 51 and a storage 52.

In the image capturing optical system 48, the zoom lens 53 for changing the photographing magnification (focal length) (see FIG. 7), the focusing lens unit 56 for adjusting the focus position (see FIG. 7) and a diaphragm 54 for adjusting the quantity of light incident on the image sensor 19 described later or the like provided in the camera body 1A are held in the direction of the optical axis L within the lens barrel 49. The image capturing optical system 48 captures the light image of the subject and forms the light image on the image sensor 19 or the like. The change of the photographing magnification (focal length) and the focus adjustment are performed by the image capturing optical system 48 being driven in the direction of the optical axis L by the AF actuator 16 within the camera body 1A.

The lens driving mechanism 50 comprises, for example, a helicoid and a non-illustrated gear or the like that rotates the helicoid, and integrally moves the image capturing optical system 48 in the direction of the arrow A parallel to the optical axis L by receiving the driving force from the AF actuator 16 through a coupler 44. The movement direction and the movement amount of the image capturing optical system 48 are responsive to the rotation direction and the number of rotations of the AF actuator 16, respectively.

The encoder 51 comprises: an encoding plate where a plurality of code patterns are formed with predetermined pitches in the direction of the optical axis L within the movement range of the image capturing optical system 48; and an encoder brush that moves integrally with the lens barrel 49 while sliding on the encoding plate, and is provided for detecting the movement amount at the time of focus adjustment of the image capturing optical system 48.

The storage 52 provides the main controller 28 in the camera body 1A with the stored contents when the lens unit 2 is attached to the camera body 1A and the main controller 28 in the camera body 1A makes a request for data. The storage 52 stores information on the movement amount of the image capturing optical system 48 outputted from the encoder 51, and stores lens codes for identifying the kind of the lens unit or coefficients A0 to A2 for calculating the blur compensation amount. Details thereof will be described later.

On the other hand, as shown in FIG. 6, the in-unit AF driving type lens unit 2 comprises, like the body AF driving type lens unit, the image capturing optical system 48, the lens barrel 49, the lens driving mechanism 50 and the encoder 51, and comprises the lens controller 55.

The lens controller 55 comprises, for example, a microcomputer incorporating a storage (storage 55b described later) comprising a ROM storing a control program or a flash memory temporarily storing data. The lens controller 55 has a communication portion 55a performing communication with the main controller 28 of the camera body 1A, and although details will be described later, transmits data such as the focal length of the zoom lens 53 to the main controller 28 and receives data such as the driving amount of the focusing lens 56 from the main controller 28.

Moreover, the lens controller 55 has the storage 55b for storing data such as the focal length of the zoom lens 53 to be transmitted from the communication portion 55a to the main controller 28 and data such as the driving amount of the focusing lens 56 transmitted from the main controller 28 to the communication portion 55a. Further, the lens controller 55 has, functionally, an AF driving controller 55c that controls the operation of the lens driving mechanism 50, and when receiving data such as the driving amount of the focusing lens 56 from the main controller 28, the AF driving controller 55c controls the driving of the lens driving mechanism 50 based on the data.

Next, the electric structure of the digital camera 1 according to the present embodiment will be described. FIG. 7 is a block diagram showing the overall electric structure of the digital camera 1 when the in-unit AF driving type lens unit is attached to the camera body 1A. The electric structure of the digital camera 1 when the body AF driving lens unit is attached to the camera body 1A is different from the block structure of the digital camera 1 shown in FIG. 7 in the electric structure within the lens unit 2. Since the difference has already been described with reference to FIG. 6, a description thereof is omitted. Moreover, the same members as those of FIGS. 1 to 6 are denoted by the same reference numerals.

As shown in FIG. 7, the image capturing optical system 48 corresponds to the image capturing optical system 48 shown in FIG. 6, and comprises the zoom lens 53 and the focusing lens 56. The AF actuator 16, the output shaft 18, the lens driving mechanism 50 and the encoder 51 correspond to the AF actuator 16, the output shaft 18, the lens driving mechanism 50 and the encoder 51 shown in FIG. 6, respectively. The lens controller 55 corresponds to the lens controller 55 shown in FIG. 6. The mirror unit 57 includes the quick return mirror 45 and the sub mirror 46, and the phase difference AF module 25 corresponds to the phase difference AF module 25 shown in FIG. 3. The shake detection sensor 47 corresponds to the shake detection sensor 47 shown in FIGS. 1 and 3.

The image sensor 19 corresponds to the image sensor 19 shown in FIG. 6, and the image capturing operations such as the start and end of the exposure operation of the image sensor 19 and the readout (horizontal synchronization, vertical synchronization, transfer) of the output signal of each pixel at the image sensor 19 are controlled by a timing control circuit 62 described later.

An image sensor driving mechanism 58 includes the X-axis actuator 33 and the Y-axis actuator 32, and is controlled by the main controller 28 (blur compensation controller 71 described later). The mirror driving mechanism 59 drives the quick return mirror 45 and the sub mirror 46 between the inclined position and the horizontal position, and is controlled by the main controller 28.

A signal processor 60 performs predetermined analog signal processings on the analog image signals outputted from the image sensor 19. The signal processor 60 has a CDS (correlated double sampling) circuit and an AGC (automatic gain control) circuit, and performs the noise reduction of the image signals by the CDS circuit and performs the level adjustment of the image signals by the AGC circuit.

An A/D converter 61 converts the analog image signals of R, G and B outputted from the signal processor 60 into digital image signals comprising a plurality of bits (for example, 10 bits) based on a clock CLK2 outputted from the timing control circuit 62 described later.

The timing control circuit 62 controls the operations of the image sensor 19 and the A/D converter 61 by generating clocks CLK1 and CLK2 based on a reference clock CLK0 outputted from the main controller 28 described later and outputting the clock CLK1 to the image sensor 19 and the clock CLK2 to the A/D converter 61.

An image processor 63 is provided with: a black level correction circuit 64 that corrects the black levels of the digital signals of R, G and B A/D converted by the A/D converter 61 to a reference black level; a white balance circuit (WB circuit) 65 that performs the level conversion of the digital signals of the color components of R (red), G (green) and B (blue) based on the reference of white corresponding to the light source; and a gamma correction circuit 66 that corrects the gamma characteristics of the digital signals of R (red), G (green) and B (blue).

An image memory 73 is a memory that, in the image capturing mode, temporarily stores the image data outputted from the image processor 63 and is used as the work area for performing a processing described later on the image data by the main controller 28. In the playback mode, the image memory 54 temporarily stores the image data read out from the image storage 85 described later.

A VRAM 84 which has an image signal recording capacity corresponding to the number of pixels of the LCD 5 is a buffer memory between the main controller 28 and the LCD 5. The LCD 5 corresponds to the LCD 5 of FIG. 2.

The image storage 85 comprises a memory card or a hard disk, and stores the images generated by the main controller 28.

An input operation portion 67 includes the first mode setting dial 3, the shutter button 4, the setting buttons 6, the jog dial 7, the push button 8, the main switch 10 and the second mode setting dial 11, and is provided for inputting operation information to the main controller 28.

Next, the main controller 28 will be described. In the following description, the function in a case where the body AF driving type lens unit is attached to the camera body 1A is described as well as the function in a case where the in-unit AF driving type lens unit is attached.

The main controller 28 controls the drivings of the members in the digital camera 1 shown in FIG. 7 so as to be associated with one another, and in the present embodiment, the main controller 28 has, functionally, an AF controller 68, a communication portion 69, a focal length calculator 70, the blur compensation controller 71 and a storage 72.

The AF controller 68 performs the focus adjustment processing by the phase difference detection method by use of the output signal of the phase difference AF module 25. When the in-unit AF driving type lens unit 2 is attached to the camera body 1A, the AF controller 68 transmits the driving amount of the focusing lens 56 necessary for obtaining in-focus state to the lens unit 2, and when the body AF driving type lens unit 2 is attached, the AF controller 68 causes the AF actuator 16 to drive the focusing lens 56 so as to be in focus.

The communication portion 69 transmits and receives various pieces of data to and from the lens unit 2 when the in-unit AF driving type lens unit 2 or the body AF driving type lens unit 2 is attached to the camera body 1A. An example of the data received from the lens unit 2 is, in the present embodiment, data for performing blur compensation, and as described later, the data for performing blur compensation differs according to the kind of the lens unit.

A description necessary for explaining the data for performing blur compensation will be given.

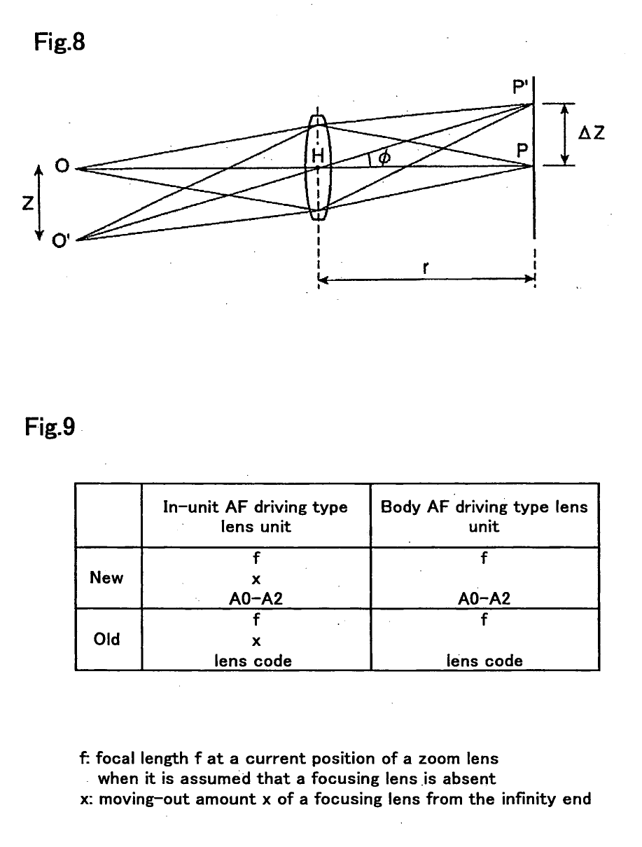

A case will be considered where a camera shake occurs in a case where the light from a certain subject O is formed into an image in a central position P of the image capturing surface of the image sensor 19 when no shake is occurring on the digital camera 1 as shown in FIG. 8. In FIG. 8, the movements, in the direction of the arrow Z, of various lenses in the lens unit 2 and the image sensor 19 with respect to the subject O due to a camera shake are represented as movements, in the direction of the arrow Z, of the subject O with respect to the image sensor 19 and the like. Although the blur amount with respect to the lens diameter is extremely small in actuality, in FIG. 8, for the sake of the viewability of the figure, the blur amount is shown as being large. Further, although the lens unit 2 of the present embodiment comprises a plurality of lens elements, in FIG. 8, these lens elements are shown as one lens.

When the subject O relatively moves with respect to the image sensor 19 and the like due to a camera shake, the image formation point of the light from the subject O moves from the point P to the point P′. At this time, when the distance from the point P to the point P′ is ΔZ, the image captured by the image sensor 19 is blurred by ΔZ due to the camera shake. Therefore, in the present embodiment performing blur compensation by driving the image sensor 19, in this case, the image sensor 19 is driven upward by ΔZ so that the image formation point of the light from the subject O is held at the central point P of the image sensor 19.

When the distance from the rear principal point H to the image formation point P of the image capturing optical system 48 in the lens unit 2 is r and the angle between the straight line passing through the rear principal point H and the image formation point P and the straight line passing through the rear principal point H and the image formation point P′ (hereinafter, referred to as blur angle) is Φ, from FIG. 8, the blur amount ΔZ can be expressed as
ΔZ=r tan Φ (1).

Since the blur angle Φ can be derived by the shake detection sensor 47, it is understood that the blur amount ΔZ can be derived if the distance r from the rear principal point H to the image formation point P can be obtained.

Although the lens unit 2 in the digital camera 1 of the present embodiment is provided with the zoom lens 53 and has the magnification varying function, when the kind of the zoom lens provided in the lens unit 2 is different, the distance r from the rear principal point H to the image formation point P is different even when the photographing magnification is the same. Moreover, the lens unit 2 is provided with the focusing lens 56 and has the focus adjustment function, and when the focusing lens 56 is driven to perform focus adjustment after the magnification of the zoom lens 53 is set, the focal length r determined by the set photographing magnification further changes.

As described above, when the distance r from the rear principal point H to the image formation point P is defined as the focal length r, even when the shake occurring on the digital camera 1 is the same, the compensation amount for the camera shake differs according to the set focal length r.

Accordingly, in the present embodiment, blur compensation is performed according to the kind of the lens unit 2. To perform blur compensation according to the kind of the lens unit 2, the main controller 28 obtains information on the focal length from the lens unit 2 attached to the camera body 1A and derives the blur amount to be compensated for.

(Description of the Kinds of Lens Units)

While it has been mentioned that examples of the lens unit 2 attachable to the camera body 1A of the digital camera 1 according to the present embodiment include the in-unit AF driving type lens unit and the body AF driving type lens unit, these lens units can be further divided into one preregistered in the storage 72 of the main controller 28 as a lens unit attachable to the camera body 1A and one not registered in the storage 72.

Hereinafter, of the in-unit AF driving type lens unit [A], [A-1] one registered in the storage 72 will be referred to as in-unit AF driving type old lens unit and [A-2] one not registered in the storage 72 will be referred to as in-unit AF driving type new lens unit, and of the body AF driving type lens unit [B], [B-1] one registered in the storage 72 will be referred to as body AF driving type old lens unit and [B-2] one not registered in the storage 72 will be referred to as body AF driving type new lens unit.

FIG. 9 shows data transmitted from the lens unit 2 to the main controller 28 of the camera body 1A when the above-mentioned lens units 2 are attached to the camera body 1A. In FIG. 9, “old” represents ones that are preregistered as lens units attachable to the camera body 1A, and “new” represents ones that are not registered.

Between the in-unit AF driving type lens unit and the body AF driving type lens unit, since the principal component for the driving control of the focusing lens 56 is different, the main component for the storage of the data of the moving-out amount x of the focusing lens 56 is also different. That is, in the in-unit AF driving type lens unit, the lens controller 55 performs the driving control of the focusing lens 56 and stores the data of the moving-out amount x, whereas in the body AF driving type lens unit, the main controller 28 of the camera body 1A performs the driving control of the focusing lens 56 and stores the moving-out amount x.

Therefore, because of this difference, when the in-unit AF driving type lens unit is attached to the camera body 1A, the moving-out amount x of the focusing lens 56 is transmitted from the lens unit to the camera body 1A, whereas when the body AF driving type lens unit is attached to the camera body 1A, no data communication is performed between the lens unit and the camera body 1A (the communication is unnecessary) The moving-out amount x of the focusing lens 56 is the moving-out amount x of the focusing lens 56 from the infinity end (hereinafter, referred to merely as moving-out amount x) When the main switch 10 is turned on, the focusing lens 56 is reset to the infinity end.

Moreover, between the new lens unit and the old lens unit, the presence or absence of the registration in the storage 72 of the main controller 28 is different as mentioned above, and in the old lens unit, a lens code representative of the kind of the lens unit which lens code is registered in the storage 72 is transmitted to the camera body 1A when the lens unit is attached to the camera body 1A. On the other hand, when the new lens unit is attached to the camera body 1A, the communication of the lens code is not performed between the new lens unit and the camera body 1A, and instead of the lens code, the communication of the coefficients A0 to A2 described later is performed.

(Description of the Data Kinds of Each Lens Unit)

The data transmitted and received between the lens unit 2 and the camera body 1A will be described with respect to each of the above-mentioned four kinds of lens units.

[A-1] As shown in FIG. 9, when the in-unit AF driving type old lens unit is attached to the camera body 1A, the focal length f at the current position of the zoom lens 53 when it is assumed that the focusing lens 56 is absent, and the moving-out amount x and the lens code of the focusing lens 56 are transmitted from the lens unit to the camera body 1A.

[A-2] When the in-unit AF driving type new lens unit is attached to the camera body 1A, the focal length f (hereinafter, referred to merely as focal length f), the moving-out amount x of the focusing lens 56 and the coefficients A0 to A2 are transmitted from the lens unit and the camera body 1A. The coefficients A0 to A2 are coefficients constituting an arithmetic expression (2), described later, for calculating the blur compensation amount.

[B-1] When the body AF driving type old lens unit is attached to the camera body 1A, the focal length f and the lens code are transmitted from the lens unit to the camera body 1A.

[B-2] When the body AF driving type new lens unit is attached to the camera body 1A, the focal length f and the coefficients A0 to A2 are transmitted from the lens unit to the camera body 1A.

The focal length calculator 70 calculates the overall focal length r of the image capturing optical system 48 currently set by use of the data transmitted from the lens unit 2 attached to the camera body 1A. The calculation method of the focal length r will be described with respect to each of the in-unit AF driving type lens unit [A] and the body AF driving type lens unit [B]. For convenience of explanation, the body AF driving type lens unit [B] will be described first.

[B] When the lens unit attached to the camera body 1A is the body AF driving type lens unit, the driving force outputted from the AF actuator 16 is transmitted to the lens driving mechanism 50 in the lens unit 20 through the output shaft 18 and the coupler 44. At this time, the moving-out amount x of the focusing lens 56 and the coupler rotation number X are in a predetermined relationship (for example, proportional relationship).

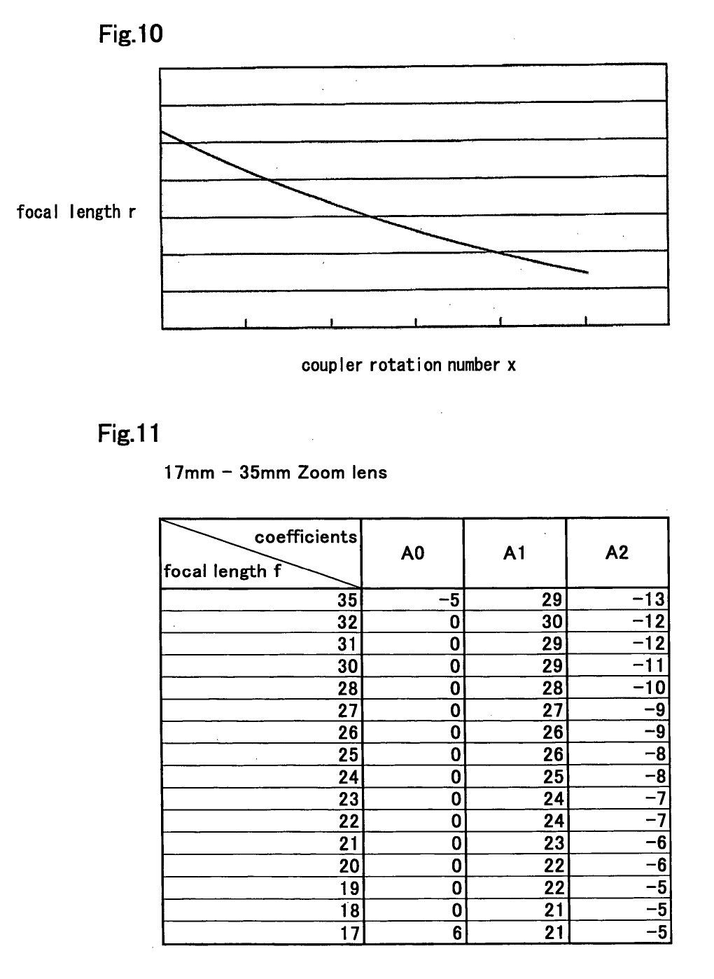

Moreover, the relationship between the coupler rotation number X and the overall focal length r of the image capturing optical system 48 differs among the lens units, and the relationship between the coupler rotation number X and the focal length r in a certain lens unit is shown in FIG. 10. In the present embodiment, in the relationship between the coupler rotation number X and the focal length r, the focal length r is expressed by being approximated to the linear function of the coupler rotation number X as shown by the following expression (2):
r=f×(1+A0×2⁻⁷+A1×2⁻¹⁰×X+A2×2⁻¹⁴×X²) (2)
Here, A0 to A2 are the coefficients.

[B-1] When the body AF driving type old lens unit is attached to the camera body 1A, the focal length f in the expression (2) and the lens code that is set according to the kind of the lens unit are transmitted from the lens unit to the main controller 28 of the camera body 1A.

In the storage 72, a look-up table (LUT, hereinafter, referred to merely as table) as shown in FIG. 11 is stored in association with each lens code. That is, a table as shown in FIG. 11 is set for each lens unit, and the table is stored in the storage 72. In this table, the focal lengths f and the values of the coefficients A0 to A2 are associated with each other.

The lens unit corresponding to the table shown in FIG. 11 is one provided with a zoom lens whose focal length f is adjustable from 17 (mm) to 35 (mm). In a case where the lens unit is attached to the camera body 1A, when the focal length f is set at 35 (mm) with the operation ring, as the coefficient A0, “−5” is transmitted from the lens unit to the main controller 28 of the camera body 1A, as the coefficient A1, “29” is transmitted, and as the coefficient A2, “−13” is transmitted.

The focal length calculator 70 substitutes the thus derived coefficients A0 to A2, the focal length f in the expression (2) received from the lens unit and the moving-out amount x of the focusing lens 56 by the AF controller 68 (stored in the storage 72 in the camera body 1A) into the expression (2) to calculate the currently set overall focal length r of the image capturing optical system 48.

[B-2] When the body AF driving type new lens unit is attached to the camera body 1A, since the focal length f in the expression (2) and the coefficients A0 to A2 are transmitted from the lens unit to the main controller 28 of the camera body 1A, the focal length calculator 70 substitutes the focal length f, the coefficients A0 to A2 and the moving-out amount x of the focusing lens 56 by the AF controller 68 (stored in the storage 72 in the camera body 1A) into the expression (2) to calculate the currently set overall focal length f of the image capturing optical system 48.

[A] On the other hand, when the lens unit attached to the camera body 1A is the in-unit AF driving type lens unit, based on the moving-out amount x of the focusing lens 56 transmitted from the lens unit, the focal length calculator 70 calculates the coupler rotation number X corresponding to the moving-out amount x by use of a predetermined arithmetic expression.

[A-1] In a case where the in-unit AF driving type old lens unit is attached to the camera body 1A, the focal length f in the expression (2) and the lens code that is set according to the kind of the lens unit together with the moving-out amount x of the focusing lens 56 are transmitted from the lens unit to the main controller 28 of the camera body 1A. Since a table as shown in FIG. 11 is stored in the storage 72 for each lens code, with reference to the table corresponding to the lens code received from the lens unit, the focal length calculator 70 derives the coefficients A0 to A2 corresponding to the focal length f received from the lens unit, and then, substitutes the coefficients A0 to A2, the focal length f and the calculated coupler rotation number X into the expression (2) to calculate the currently set overall focal length r of the image capturing optical system 48.

[A-2] When the lens unit attached to the camera body 1A is the in-unit AF driving type new lens unit, since the focal length f in the expression (2) and the coefficients A0 to A2 together with the moving-out amount x of the focusing lens 56 are transmitted from the lens unit to the main controller 28 of the camera body 1A, the focal length calculator 70 substitutes the focal length f, the coefficients A0 to A2 and the calculated coupler rotation number X into the expression (2) to calculate the currently set overall focal length r of the image capturing optical system 48.

(Description of the Blur Compensation Operation)

The blur compensation controller 71 substitutes the actual focal length r calculated by the focal length calculator 70 and the angular velocity (corresponding to the angle Φ) obtained from the detection signal of the shake detection sensor 47 into the expression (1) to calculate the driving amount ΔZ (hereinafter, referred to as blur compensation amount ΔZ) of the image sensor 19 that can compensate for (cancel out) the blur, and controls the operation of the image sensor driving mechanism 58 based on the blur compensation amount ΔZ. When the blur compensation amount ΔZ is a negative value, since this means that the image sensor 10 is driven in a direction opposite to the direction of the case of a positive value, the blur compensation amount ΔZ includes the blue compensation direction.

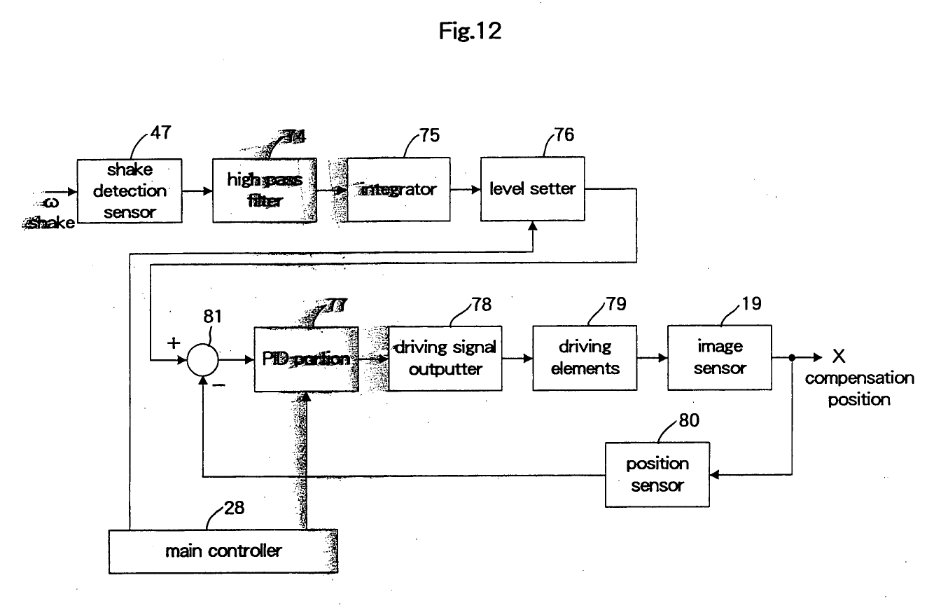

FIG. 12 is a view showing the detailed structure of the mechanism (the image sensor 19, the blur compensation controller 71, the image sensor driving mechanism 58) performing blur compensation according to the present embodiment.

As shown in FIG. 12, the shake detection sensor 47 detects a shake ω, and outputs it to a high pass filter (HPF) 74 as an angular velocity signal. The high pass filter 74 removes the DC drift and offset contained in the angular velocity signal from the shake detection sensor 47. An integrator 75 integrates the angular velocity signal having passed through the high pass filter 74 into an angle signal. A level setter 76 adjusts the level of the angle signal to convert the angle signal into a compensation position control signal in order to determine the movement amount of the image sensor 19 or the position (compensation position) to which the image sensor 19 is to be moved. The level by the level setter 76 is predetermined according to the focal length of the lens, and inputted from the main controller 28 to the level setter 76. The position of the image sensor 19 is detected by a position sensor 80. A driving signal outputter 78 generates and outputs a signal for driving elements 79 (the piezoelectric elements 34 of the X-axis actuator 33 and the Y-axis actuator 32).

A PID portion 77, the driving signal outputter 78, the driving elements 79, the image sensor 19, the position sensor 80 and a subtractor 81 constitute a feedback loop. The subtractor 81 subtracts the compensation position detection signal of the position sensor 80 from the compensation position control signal of the level setter 76. The PID portion 77 performs proportional compensation (P compensation), integral compensation (I compensation) and differential compensation (D compensation) on the output signal from the subtractor 81, and compensates for the delay transmission characteristic from the driving elements 79 to the image sensor 19.

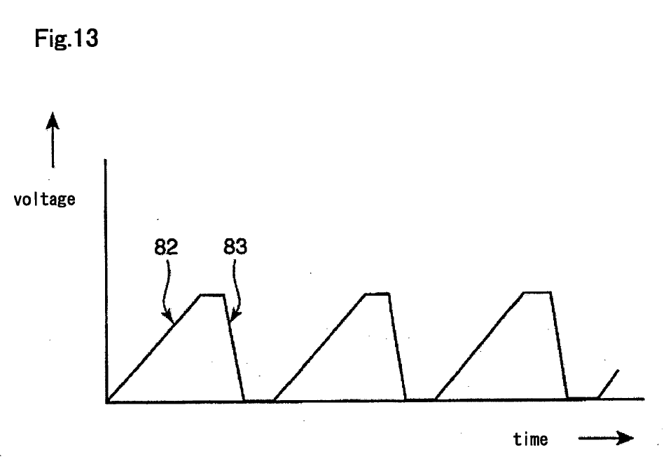

Next, the operations of the driving signal outputter 78 and the driving elements 79 will be described. When the driving of the image sensor 19 in the direction of the X-axis is determined, as shown in FIG. 13, a driving pulse of a waveform comprising gently rising parts 82 and succeeding rapidly falling parts 83 is applied to the piezoelectric element 34 of the X-axis actuator 33. In the gently rising parts 82 of the driving pulse, the piezoelectric element 34 gently expands in the direction of the thickness, and the driving shaft 35 displaces in the direction shown by the arrow a (see FIGS. 5(a), 5(b) and 6). Consequently, the substrate 30 frictionally coupled to the driving shaft 35 by the frictional coupling portion 36 also moves in the direction of the arrow a.

In the rapidly falling parts 83 of the driving pulse, the piezoelectric element 34 rapidly contracts in the direction of the thickness, and the driving shaft 35 displaces in a direction opposite to the arrow a. At this time, the substrate 30 frictionally coupled to the driving shaft 35 by the frictional coupling portion 36 substantially remains in the position against the frictional coupling force between the driving shaft 35 and the frictional coupling portion 36 because of its inertial force, and does not move. The word substantially referred to here means that one is included that follows while sliding between the frictional coupling portion 36 and the driving shaft 35 fixed to the substrate 30 in the direction of the arrow a and the opposite direction and moves in the direction of the arrow a as a whole because of the difference in driving time. The movement configuration is determined according to the friction condition being provided.

By continuously applying the driving pulse of the above-described waveform to the piezoelectric element 34, the image sensor 19 can be continuously moved in the positive direction of the X-axis.

The movement of the image sensor 19 in the negative direction of the X-axis, that is, in the direction opposite to the arrow a can be achieved by applying a driving pulse of a waveform comprising rapidly rising parts 82 and succeeding gently falling parts 83 to the piezoelectric element 34. When the image sensor 19 is moved to a predetermined position, the supply of the driving pulse is stopped, so that the movement of the image sensor 19 is stopped.

The driving of the image sensor 19 in the direction of the Y-axis is substantially similar to the driving of the image sensor 19 in the direction of the X-axis.

Returning to FIG. 7, with respect to the in-unit AF driving type old lens unit and the body AF driving type old lens unit, the storage 72 stores the correspondence between the lens code and the table that are set for each lens unit and stores, in a table format, the relationship between the focal length f of the lens unit and the coefficients A0, A1 and A2 as shown in FIG. 11.

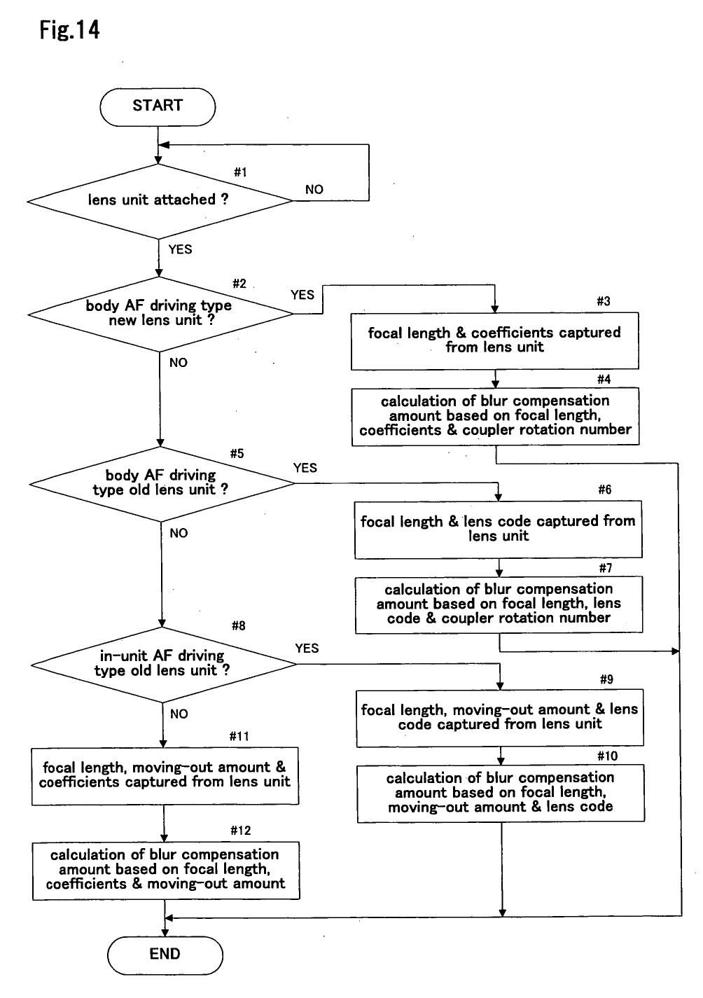

Next, the blur compensation processing by the digital camera 1 according to the present invention will be described. FIG. 14 is a flowchart showing the processing performed according to the kind of the lens unit attached to the camera body 1A.

As shown in FIG. 14, in a case where the lens unit 2 is attached to the camera body 1A (YES at step #1), when the attached lens unit 2 is the body AF driving type new lens unit (YES at step #2), the main controller 28 captures the focal length f and the coefficients A0 to A2 from the lens unit 2 (step #3), and calculates the blur compensation amount ΔZ by use of these pieces of data and the coupler rotation number x corresponding to the driving amount of the focusing lens 56 by the control by the AF controller 68 (step #4).

When the attached lens unit 2 is the body AF driving type old lens unit (NO at step #2, YES at step #5), the main controller 28 captures the focal length f and the lens code from the lens unit 2 (step #6), and calculates the blur compensation amount ΔZ by use of these pieces of data and the coupler rotation number X corresponding to the driving amount of the focusing lens 56 by the control by the AF controller 68 (step #7). In this case, the coefficients A0 to A2 are derived from the lens code and the focal length f by use of the table stored in the storage 72.

In the case of the in-unit AF driving type old lens unit (NO at steps #2 and #5, YES at step #8), the main controller 28 captures the focal length f, the moving-out amount x of the focusing lens 56 and the lens code from the lens unit (step #9), and calculates the blur compensation amount ΔZ by use of these pieces of data (step #10). In this case, the moving-out amount x of the focusing lens 56 is converted into the coupler rotation number by a predetermined arithmetic expression, and the coefficients A0 to A2 are derived from the lens code and the focal length f by use of the table stored in the storage 72.

In the case of the in-unit AF driving type new lens unit (NO at steps #2, #5, #8), the main controller 28 captures the focal length f, the moving-out amount x of the focusing lens 56 and the coefficients A0 to A2 from the lens unit 2 (step #11), and calculates the blur compensation amount ΔZ by use of these pieces of data (step #12). In this case, the moving-out amount x of the focusing lens 56 is converted into the coupler rotation number by a predetermined arithmetic expression.

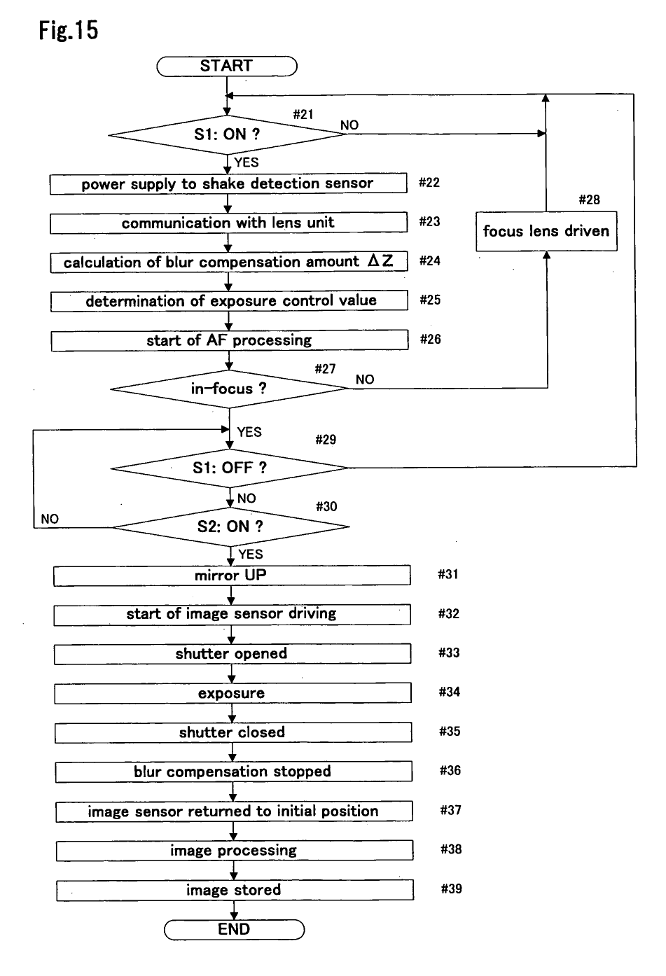

A series of image capturing processings by the digital camera 1 according to the present embodiment will be described. FIG. 15 is a flowchart showing the image capturing processings. In this example, the lens unit 2 is already attached to the camera body 1A.

As shown in FIG. 15, the main controller 28 determines whether the half depression (S1: ON) of the shutter button 4 is performed or not (step #21), and when the half depression is not performed, the main controller 28 waits until the half depression is performed (NO at step #21). When the half depression of the shutter button 4 is performed (YES at step #21), the main controller 28 starts the power supply to the shake detection sensor 47 (step #22), and communicates data such as the focal length f corresponding to the lens unit with the lens unit (step #23).

The main controller 28 calculates the blur compensation amount ΔZ by use of the data received from the lens unit 2 (step #24). The calculation of the blur compensation amount ΔZ is performed in order that the blur compensation operation (the driving operation of the image sensor 19) can be rapidly performed when the full depression of the shutter button 4 is performed. While the blur compensation operation (the driving operation of the image sensor 19) may be started at this point of time, for the reduction in power consumption and the prevention of breakage of the X-axis actuator 33 and the Y-axis actuator 32, the processings are performed only up to the calculation of the blur compensation amount ΔZ.

The main controller 28 determines the exposure control values (the shutter speed and the aperture value) based on the brightness of the subject (step #25), and starts the AF processing by the phase difference detection method (step #26).

The main controller 28 (the AF controller 68) determines whether in-focus state is obtained or not (step #27) When in-focus state is not obtained (NO at step #27), the main controller 28 drives the focusing lens 56 based on the driving direction and the driving amount determined by the focus adjustment processing (AF processing) performed at step S26 (step #28), and then, returns to the processing of step #21 and repeats the processing from steps #21 to #26.

When in-focus state is obtained (YES at step #27), the main controller 28 determines the operation condition of the shutter button 4. That is, the main controller 28 determines whether the half depression of the shutter button 4 is canceled or not (step #29). When the half depression is canceled (YES at step #29), the main controller 28 returns to the processing of step #21, and when the half depression is not canceled (NO at step S29), the main controller 28 determines whether the full depression (S2: ON) of the shutter button 4 is performed or not (YES at step #30). When the full depression of the shutter button 4 is not performed (NO at step #30), the main controller 28 returns to the processing of step #29.

When the full depression of the shutter button 4 is performed (YES of step #30), the main controller 28 causes the mirror driving mechanism 59 to perform driving so that the quick return mirror 45 and the sub mirror 46 are brought into the horizontal position (mirror up) (step #31), and the blur compensation controller 71 performs the calculation of the blur compensation amount ΔZ and the driving control of the image sensor 19 in order to perform the blur compensation operation (step #32).

Then, the main controller 28 opens the shutter unit 20 (step #33), and causes the image sensor 19 to perform the image capturing operation (exposure operation) with the exposure control values set at step #25 with the focusing lens 56 being situated in the position set at step #27 (step #34).

Then, the main controller 28 closes the shutter unit 20 (step #35), stops the calculation of the blur compensation amount ΔZ and the driving control of the image sensor 19 (step #36), and returns the image sensor 19 to the original position (initial position) (step #37). The original position is, for example, a position where the center of the image sensor 19 passes through the optical axis of the image capturing optical system 48.

The main controller 28 performs image processings such as compression processing on the image obtained by the image capturing operation of the image sensor 19 (step #38), and stores the image having undergone the image processings into the image storage 85 (step #39). Moreover, in parallel with the processings of steps #35 to #39, the main controller 28 causes the mirror driving mechanism 59 so that the quick return mirror 45 and the sub mirror 46 are brought into the inclined position (mirror down). Although the digital camera according to the present embodiment is a single-lens reflex camera in which a lens unit having a zoom lens is interchangeably attached to a camera body, a single-lens reflex camera in which a lens unit having a fixed focal length lens is interchangeably attached to a camera body may be employed.

As described above, in the digital camera 1 of the present embodiment, when the lens unit 2 is attached to the camera body 1A, the main controller 28 of the camera body 1A obtains the data necessary for calculating the currently set overall focal length r of the image capturing optical system 48 from the lens unit 2, calculates the focal length r by use of this data, and obtains the blur compensation amount ΔZ based on the expression (1) from the focal length r and the blur amount obtained by the detection signal of the shake detection sensor 47, so that blur compensation can be reliably performed irrespective of which of the four kinds of lens units 2 is attached to the camera body 1A.

Moreover, since a structure driving the image sensor 19 in two orthogonal axial directions on the image capturing surface is adopted as the structure performing blur compensation, compared to a structure having an optical system for blur compensation for each lens unit and performing blur compensation by use of the optical system, cost increase and size increase of the lens unit 2 can be prevented or suppressed.

According to the present invention, compared to a case where an optical system for blur compensation and a driver for driving it are provided in the lens unit, it is unnecessary to perform the communication processing to transmit and receive the information on the blur compensation amount and the blur compensation direction obtained by the blur compensation controller between the camera body and the lens unit and the period of the blur compensation operation can be reduced accordingly, so that more accurate blur compensation can be performed.

Further, according to the present invention, appropriate blur compensation can be performed according to the lens unit attached to the camera body. Moreover, since at least the focal length deriver and the blur compensation controller are provided in the camera body, compared to a case where these are provided for each of different kinds of lens units, cost increase and size increase of the lens unit can be prevented or suppressed. When the shake detector is provided in the camera body, cost increase of the lens unit and size increase of the interchangeable lens can be further prevented or suppressed.

In the present invention, the modifications described in the following modes (1) and (2) are adoptable in addition to the above-described embodiment or instead of the above-described embodiment:

(1) The present invention is applicable even when the means for compensating for a blur is an optical element that optically compensates for a blur (for example, a blur compensation lens).

(2) The sensor that performs the detection of a camera shake amount in the present embodiment is not limited to an angular velocity sensor as described above but may be an acceleration sensor.

(3) While in the above-described embodiment, the blur compensation operation is always performed when the main power of the digital camera 1 is on, the present invention is not limited thereto. Since there can be cases where photographing is performed with a blur being caused, the blur compensation operation as described above may be performed in a case where a button for alternatively selecting a blur compensation mode to perform blur compensation by the image sensor driving mechanism 58 and the image sensor 19 described later and a non-blur compensation mode not to perform blur compensation is provided and the blur compensation mode is set by the button.

Although the present invention has been fully described by way of examples with reference to the accompanying drawings, it is to be noted here that various changes and modifications will be apparent to those skilled in the art. Therefore, unless otherwise such changes and modifications depart from the scope of the present invention, they should be construed as being included therein.

1. A digital camera comprising:
a camera body; and
a lens unit detachable from said camera body and having an image taking optical system;
said camera body further comprising:
a communication portion configured to receive an information on a focal length of the image taking optical system from the lens unit;
a shake detector that detects a camera shake on the digital camera, and outputs a shake detection signal;
a blur compensator configured to receive a blur compensation amount and compensates for a blur, due to the camera shake, of a subject light image projected onto an image capturing surface of an image sensor provided in the camera body, based on the received blur compensation amount;
a focal length deriver provided configured to obtain an overall focal length of the image taking optical system, by use of the information on the focal length obtained by the communication portion; and
a blur compensation controller configured to derive the blur compensation amount for compensating for the blur based on the overall focal length of the image taking optical system obtained by the focal length deriver and the shake detection signal outputted from the shake detector, and outputs the blur compensation amount to the blur compensator.

2. A digital camera as claimed in claim 1, wherein the image taking optical system in the lens unit includes a magnification varying optical system.

3. A digital camera as claimed in claim 1, wherein the blur compensation amount includes a blur compensation direction.

4. A digital camera as claimed in claim 3, wherein the blur compensator includes the image sensor having the image capturing surface on an image forming surface thereof, and a driver that drives the image sensor in two orthogonal directions on the image forming surface, and said driver performs blur compensation by driving the image sensor based on the blur compensation amount and the blur compensation direction outputted from the blur compensation controller.

5. A digital camera as claimed in claim 3, wherein the blur compensator includes an optical element to optically compensate for blur.

6. A digital camera as claimed in claim 2, wherein the focal length deriver further comprising:
a calculator that calculates the overall focal length of the image taking optical system by use of a predetermined arithmetic expression from a coefficient and the currently set focal length by the magnification varying optical system of the lens unit when the lens unit is attached to the camera body.

7. A digital camera as claimed in claim 6, wherein the focal length deriver further comprising:
a coefficient storage that stores the coefficient set according to the focal length settable by the magnification varying optical system, for each lens unit attachable to the camera body; and wherein said calculator of the focal length deriver reads out, when the lens unit whose coefficient is stored in the coefficient storage is attached to the camera body, the coefficient corresponding to the focal length currently set by the magnification varying optical system of the lens unit from the coefficient storage, and calculates the overall focal length of the image taking optical system by use of the predetermined arithmetic expression from the coefficient and the currently set focal length.

8. A digital camera as claimed in claim 6, wherein the lens unit further comprising:
a coefficient storage that stores a coefficient set according to the focal length settable by the magnification varying optical system; and
a coefficient outputter that outputs the coefficient stored in the coefficient storage to the focal length deriver when the lens unit is attached to the camera body, wherein the calculator of the focal length deriver calculates the overall focal length of the image taking optical system by use of the predetermined arithmetic expression from the coefficient outputted from the coefficient outputter and the focal length currently set by the magnification varying optical system of the lens unit when the lens unit is attached to the camera body.

9. A digital camera as claimed in claim 6, wherein the image taking optical system is provided with a focus adjustment optical system for performing focus adjustment, the predetermined arithmetic expression includes a driving amount of the focus adjustment optical system as a variable, and the calculator calculates the overall focal length of the image taking optical system by use of the predetermined arithmetic expression from the coefficient, the currently set focal length by the magnification varying optical system, and the driving amount of the focus adjustment optical system.

10. A digital camera as claimed in claim 9, wherein the camera body further comprising:
a second driver that drives the focus adjustment optical system in a direction of an optical axis;
a second driving controller that controls an operation of the second driver; and
a driving amount outputter that outputs, to the focal length deriver, information on a driving amount of the focus adjustment optical system driven by the second driver under the control by the second driving controller when the lens unit having the focus adjustment optical system driven by the second driver and the second driving controller is attached to the camera body.

11. A digital camera as claimed in claim 9, wherein the lens unit further comprising:
a second driver that drives the focus adjustment optical system in a direction of an optical axis;
a second driving controller that controls an operation of the second driver; and
a driving amount outputter that outputs, to the focal length deriver, information on a driving amount of the focus adjustment optical system driven by the second driver under the control by the second driving controller when the lens unit is attached to the camera body.

12. A digital camera body to which a lens unit having an image taking optical system is attachable, said camera body comprising:
a communication portion configured to receive an information on a focal length of the image taking optical system from the lens unit;
a shake detector that detects a camera shake on the digital camera, and outputs a shake detection signal;
a blur compensator configured to receive a blur compensation amount and compensates for a blur, due to the camera shake, of a subject light image projected onto an image capturing surface of an image sensor provided in the camera body, based on the received blur compensation amount;
a focal length deriver configured to obtain an overall focal length of the image taking optical system, by use of the information on the focal length obtained by the communication portion; and
a blur compensation controller configured to derive the blur compensation amount for compensating for the blur based on the overall focal length of the image taking optical system obtained by the focal length deriver and the shake detection signal outputted from the shake detector, and outputs the blur compensation amount to the blur compensator.

13. A digital camera body as claimed in claim 12, wherein the image taking optical system in the lens unit includes a magnification varying optical system.

14. A digital camera body as claimed in claim 12, wherein the blur compensation amount includes a blur compensation direction.

15. A digital camera body as claimed in claim 14, wherein the blur compensator includes the image sensor having the image capturing surface on an image forming surface thereof, and a driver that drives the image sensor in two orthogonal directions on the image forming surface, and said driver performs blur compensation by driving the image sensor based on the blur compensation amount and the blur compensation direction outputted from the blur compensation controller.

16. A digital camera as claimed in claim 14, wherein the blur compensator includes an optical element to optically compensate for blur.

17. A digital camera as claimed in claim 14, wherein the focal length deriver further comprising:
a calculator that calculates the overall focal length of the image taking optical system by use of a predetermined arithmetic expression from a coefficient and the currently set focal length by the magnification varying optical system of the lens unit when the lens unit is attached to the camera body.

18. A digital camera as claimed in claim 17, wherein the calculator receives a coefficient corresponding to the focal length currently set by the magnification varying optical system of the lens unit attached to the camera body, from either a storage provided in the camera body or a storage provided in the lens unit.

19. A digital camera body as claimed in claim 17, wherein the calculator calculates the overall focal length of the image taking optical system in the lens unit attached to the camera body by use of the predetermined arithmetic expression from the coefficient, the currently set focal length by the magnification varying optical system, and the driving amount of a focus adjustment optical system included in the image taking optical system of the lens unit.

20. A digital camera as claimed in claim 19, wherein the camera body further comprising:
a second driver that drives the focus adjustment optical system in a direction of an optical axis;
a second driving controller that controls an operation of the second driver; and
a driving amount outputter that outputs, to the focal length deriver, information on a driving amount of the focus adjustment optical system driven by the second driver under the control by the second driving controller when the lens unit having the focus adjustment optical system driven by the second driver and the second driving controller is attached to the camera body.
